(19) United States
(12) Patent Application Publication
(10) Pub. No.: US 2014/0073158 A1
(43) Pub. Date: Mar. 13, 2014

(54) WATERPROOF ELECTRICAL SOCKET CONNECTOR

(71) Applicant: Taiwan Misaki Electronics Co., LTD., Taoyuan City (TW)

(72) Inventor: Wen-Jen HONG, Taoyuan City (TW)

(21) Appl. No.: 14/020,552

(22) Filed: Sep. 6, 2013

(30) Foreign Application Priority Data
Sep. 13, 2012 (TW) 101217756
Nov. 27, 2012 (CN) 201220637403.3

(51) Int. Cl. H01R 13/52

(52) U.S. Cl. CPC H01R 13/52
USPC 439/188; 439/660

(57) ABSTRACT

A waterproof electrical socket connector includes a connector housing and a plurality of contact members. The connector housing includes a first housing portion and a second housing portion coupled to and configured to cover the first housing portion. The first and second housing portions define a cavity and an opening configured to permit extension of a plug into the cavity. Each of the contact members includes a terminal portion disposed outwardly of the connector housing, a contact portion for establishing electrical contact with the plug, and an embedding portion that interconnects the terminal portion and the contact portion and that is embedded in the first housing portion by insert molding.

### CROSS-REFERENCE TO RELATED APPLICATIONS

This application claims priority of Taiwanese Application No. 101217756, filed on Sep. 13, 2012, and China Application No. 201220637403.3, filed on Nov. 27, 2012.

### BACKGROUND OF THE INVENTION

1. Field of the Invention

The invention relates to an electrical socket connector, more particularly to a waterproof electrical socket connector.

2. Description of the Related Art

Referring to FIG. 1, a conventional electrical socket connector 200 includes a housing 210, a plurality of contact members 220, 230, 240, 250, a detecting switch 260, and a positioning member 270. The housing 210 defines a cavity 211 extending along an axis, and a circular opening 212 that is disposed along the axis at one end of the cavity 211 and that is configured to permit extension of a plug (not shown) into the cavity 211. Two lateral sides of the housing 210 are further formed with a plurality of engaging grooves 213, 214, 215, 216. Each of the contact members 220, 230, 240, 250 includes a terminal portion that is disposed outwardly of the housing 210, a contact portion that extends into the cavity 211 for establishing electrical contact with the plug, and an engaging portion 222, 232, 242, 252 that interconnects the terminal portion and the contact portion and that engages a respective one of the engaging grooves 213, 214, 215, 216 of the housing 210. The detecting switch 260 is disposed at the other end of the cavity 211 opposite to the circular opening 212, and includes a first switch component 261 and a second switch component 262. The first switch component 261 has a contact portion that is disposed in the cavity 211. The second switch component 262 has a contact portion that is disposed in the cavity 211, that extends adjacent to the contact portion of the first switch component 261, and that is urged by the plug to make contact with the contact portion of the first switch component 261 when the plug is extended into the cavity 211. The positioning member 270 is disposed on a top portion of the housing 210 that is adjacent to the other end of the cavity 211.

The contact members 220, 230, 240, 250 are coupled to the housing 210 through the engagements between the engaging portions 222, 232, 242, 252 and the respective engaging grooves 213, 214, 215, 216. However, gaps exist when the engaging portions 222, 232, 242, 252 of the contact members 220, 230, 240, 250 engage respectively the engaging grooves 213, 214, 215, 216. Such configuration is not waterproof. Therefore, there is a need in the art to develop an electrical socket connector that is waterproof.

### SUMMARY OF THE INVENTION

Therefore, the object of the present invention is to provide a waterproof electrical socket connector.

Accordingly, a waterproof electrical socket connector of the present invention is adapted for coupling to a plug and comprises:

a connector housing including a first housing portion and a second housing portion coupled to and configured to cover the first housing portion, the first housing portion and the second housing portion cooperatively defining a cavity and an opening that is configured to permit extension of the plug into the cavity; and

a plurality of contact members each of which includes a terminal portion, a contact portion, and an embedding portion that interconnects the terminal portion and the contact portion, the embedding portion being fittingly and sealingly embedded in the first housing portion by insert molding, the terminal portion extending outwardly of the first housing portion, the contact portion extending into the cavity for establishing electrical contact with the plug.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of a conventional electrical socket connector;

FIG. 2 is a perspective view of a first preferred embodiment of a waterproof electrical socket connector according to the present invention;

FIG. 3 is an exploded view of the first preferred embodiment;

FIG. 4 is a fragmentary perspective view of the first preferred embodiment to illustrate a first housing portion, a detecting switch and a plurality of contact members;

FIG. 5 is a fragmentary perspective view of the first preferred embodiment to illustrate the detecting switch and the contact members;

FIG. 6(a) is a fragmentary side view showing an embedding portion of the contact member;

FIG. 6(b) is a fragmentary front view showing the embedding portion of the contact member;

FIG. 7(a) is a fragmentary side view showing an embedding portion of a first switch component of the detecting switch;

FIG. 7(b) is a fragmentary front view showing the embedding portion of the first switch component of the detecting switch;

FIG. 8(a) is a fragmentary side view showing an embedding portion of a second switch component of the detecting switch;

FIG. 8(b) is fragmentary front view showing the embedding portion of the second switch component of the detecting switch;

FIG. 9 is a schematic diagram illustrating a state in which a contact portion of the second switch component does not establish electrical contact with a contact portion of the first switch component of the detecting switch;

FIG. 10 is a schematic diagram illustrating another state in which the contact portion of the second switch component is urged by the plug to establish electrical contact with the contact portion of the first switch component of the detecting switch;

FIG. 11 is a perspective view of a second preferred embodiment of the waterproof electrical socket connector according to the present invention;

FIG. 12 is an exploded view of the second preferred embodiment;

FIG. 13 is a perspective view of a third preferred embodiment of the waterproof electrical socket connector according to the present invention; and

FIG. 14 is an exploded view of the third preferred embodiment.

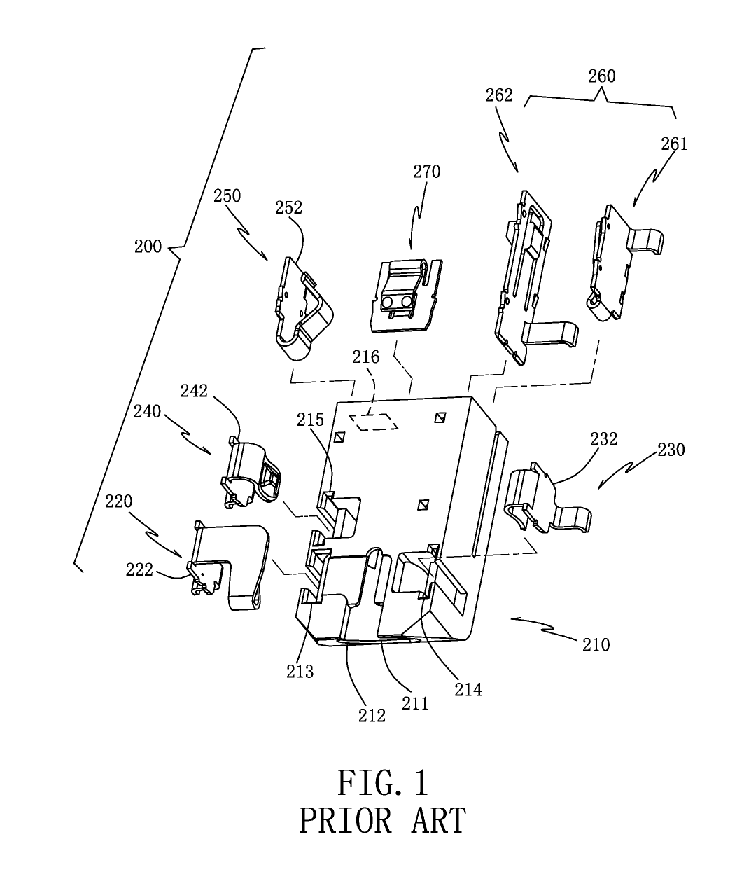

### DETAILED DESCRIPTION OF THE PREFERRED EMBODIMENTS

Before the present invention is described in greater detail, it should be noted that like elements are denoted by the same reference numerals throughout the disclosure.

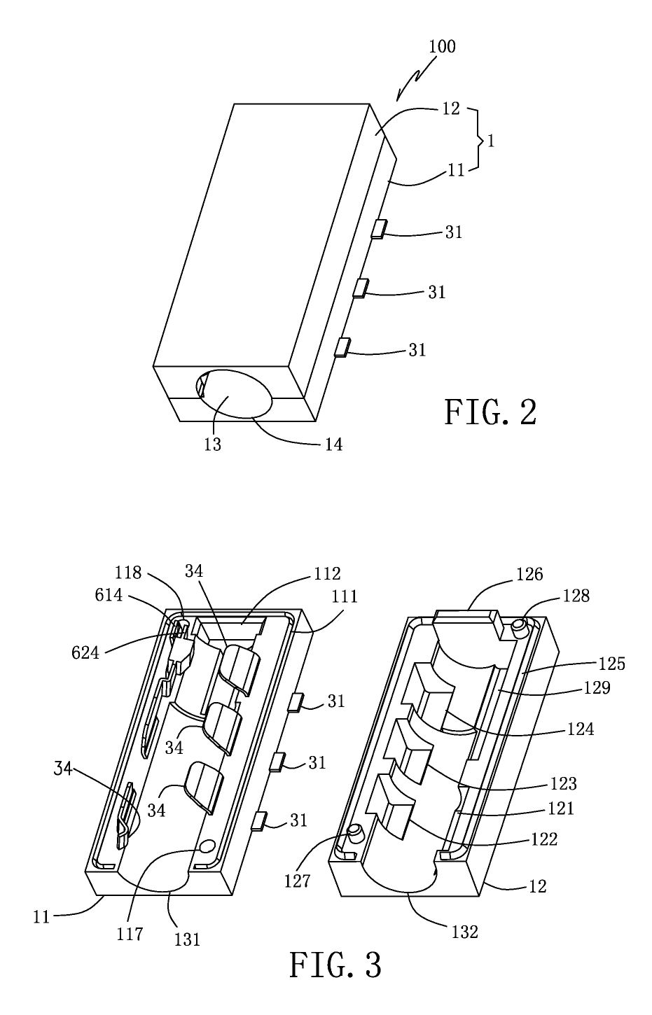

Referring to FIGS. 2 to 10, the first preferred embodiment of a waterproof electrical socket connector 100 according to the present invention is adapted for coupling with a plug 8 (see FIG. 10) and is shown to include a connector housing 1, a plurality of contact members 3, and a detecting switch 6. Although the first preferred embodiment of the waterproof electrical socket connector 100 is exemplified as an audio jack, the present invention is not limited in this respect.

The connector housing 1 is made of an insulating material and includes a first housing portion 11 and a second housing portion 12 coupled to and configured to cover the first housing portion 11. The first housing portion 11 and the second housing portion 12 cooperatively define a cavity 13 and an opening 14 that is configured to permit extension of the plug 8 into the cavity 13. In this embodiment, the cavity 13 extends along an axis, and the opening 14 is circular and is disposed along the axis at one end of the cavity 13 (see FIG. 2). The first housing portion 11 and the second housing portion 12 have confronting cavity defining surfaces 131, 132 that cooperate to define the cavity 13. In this embodiment, the second housing portion 12 is further formed with a plurality of first recesses 121, 122, 123, 124, and a second recess 129 that are in spatial communication with the cavity 13.

Preferably, the cavity defining surface 131, 132 of one of the first and second housing portions 11 and 12 is formed with a male engaging part 126 that extends into the cavity 13 at a location distal from the opening 14, and the cavity defining surface 131 and 132 of the other one of the first and second housing portions 11 and 12 is formed with a female engaging part 112 to engage the male engaging part 126 (see FIG. 3).

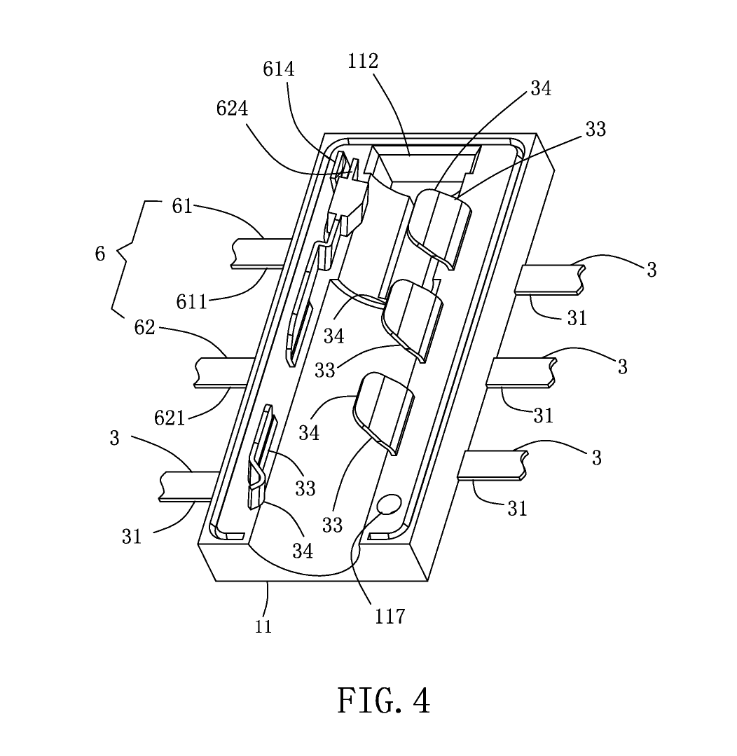

Preferably, the first housing portion 11 and the second housing portion 12 have confronting mating surfaces provided with a pair of joint structures that are diagonally opposite to each other. Each of the joint structures includes a tenon 127, 128 provided on the mating surface of one of the first and second housing portions 11, 12, and a motise 117, 118 provided on the mating surface of the other one of the first and second housing portions 11, 12 and disposed to engage the tenon 127, 128. In this embodiment, the tenons 127, 128 of the joint structures are provided on the mating surface of the second housing portion 12, and the motises 117, 118 are provided on the mating surface of the first housing portion 11 (see FIGS. 3 and 4).

Preferably, the mating surface of one of the first and second housing portions 11, 12 is formed with an elongate rib 125, and the mating surface of the other one of the first and second housing portions 11 and 12 is formed with an elongate trench 111 to engage the elongate rib 125. In this embodiment, the opening 14 is disposed at one end of the cavity 13, and the elongate rib 125 and the elongate trench 111 are configured to surround two lateral sides of the cavity 13 and another end of the cavity 13 opposite to the opening 14 (see FIGS. 3 and 4).

The contact members 3 are made of a metallic material and are resiliently deformable and electrically conductive. In this embodiment, four metal strips serve as the contact members 3. Each of the contact members 3 includes a terminal portion 31, a contact portion 34, and an embedding portion 32 interconnecting the terminal portion 31 and the contact portion 34. In this embodiment, each of the contact members 3 further includes a connecting portion 33 connecting the embedding portion 32 to the contact portion 34. The embedding portions 32 are fittingly and sealingly embedded in the first housing portion 11 by insert molding. The terminal portions 31 of the contact members 3 are disposed outwardly of the first housing portion 11. The contact portion 34 of each of the contact members 3 is received in a respective one of the first recesses 121, 122, 123, 124 and extends into the cavity 13 for establishing electrical contact with the plug 8. The insert molding technique provides a waterproof effect between the embedding portions 32 and the first housing portion 11.

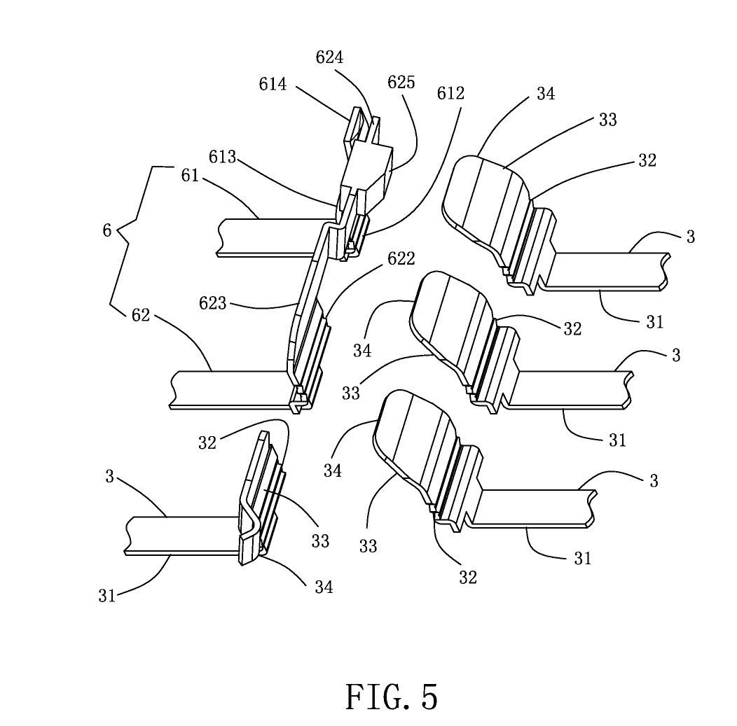

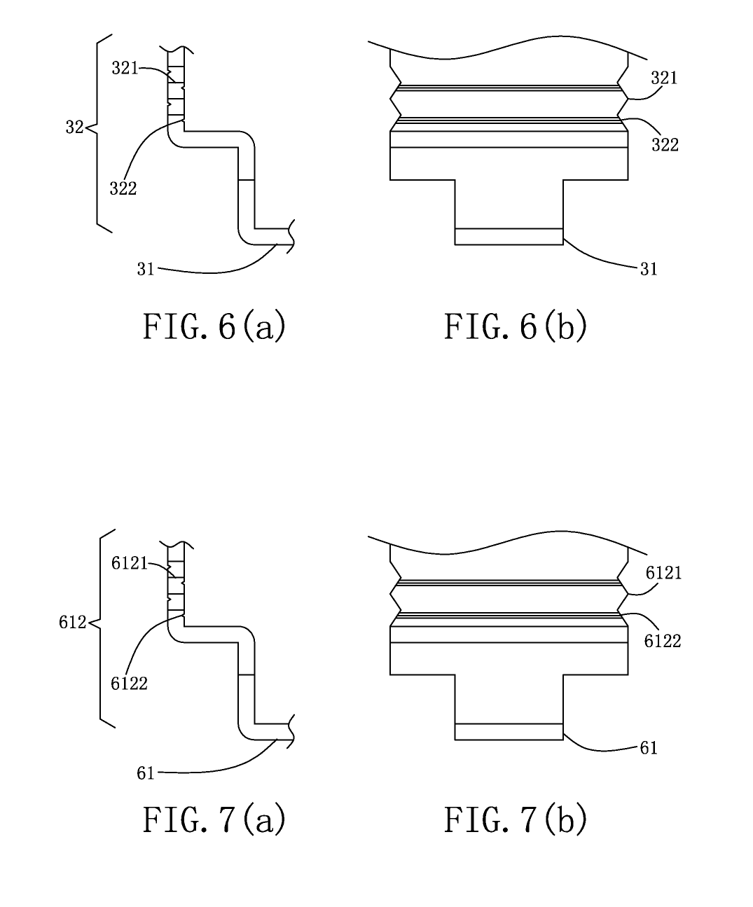

Preferably, as shown in FIGS. 5, 6(a), and 6(b), the embedding portion 32 of each of the contact members 3 has a surface formed with at least one groove 322. Preferably, the embedding portion 32 of each of the contact members 3 further has at least one protrusion 321 protruding therefrom and embedded in the first housing portion 11. The protrusion 321 of the embedding portion 32 of each of the contact members 3 is capable of enhancing engagement between each of the embedding portions 32 and the first housing portion 11. As for the groove 322, when moisture tends to leak via the cavity 13 and through the first housing portion 11 attributed to the different materials of the connector housing 1 and the contact members 3, which have different thermal expansion coefficients, after long working period of the waterproof electrical socket connector 100, the liquid will be retained in the groove 322, so as to further assure the waterproofing effect of the first preferred embodiment.

As shown in FIGS. 2 to 5, 7(a) and 7(b), and 8(a) and 8(b), the detecting switch 6 is made of a metallic material and is resiliently deformable and electrically conductive. The detecting switch 6 includes a first switch component 61 and a second switch component 62. The first switch component 61 has a terminal portion 611, a contact portion 614, and an embedding portion 612 that interconnects the terminal portion 611 and the contact portion 614. In this embodiment, the first switch component 61 further includes a connecting portion 613 connecting the embedding portion 612 to the contact portion 614. The embedding portion 612 of the first switch component 61 is fittingly and sealingly embedded in the first housing portion 11 by insert molding. The terminal portion 611 of the first switch component 61 extends outwardly of the first housing portion 11. The contact portion 614 is received in the second recess 129 and extends into the cavity 13. The second switch component 62 has a terminal portion 621, a contact portion 624, and an embedding portion 622 that interconnects the terminal portion 621 and the contact portion 624 thereof. The embedding portion 622 of the second switch component 62 is fittingly and sealingly embedded in the first housing portion 11 by insert molding. The terminal portion 621 of the second switch component 62 extends outwardly of the first housing portion 11. In this embodiment, the second switch component 62 further includes a connecting portion 623 connecting the embedding portion 622 to the contact portion 624. The connecting portion 623 is configured as a resilient and electrically conductive strip having a connecting end connected to the embedding portion 622 and an opposite end that is distal from the connecting end and that is connected to the contact portion 624. The contact portion 624 is received in the second recess 129 and extends adjacent to the contact portion 614 of the first switch component 61 and into the cavity 13. In this embodiment, the contact portion 624 is further provided with an abutting part 625 that is an electrical insulator and that is adapted for abutting against the plug 8 when the plug 8 is extended into the cavity 13.

As shown in FIGS. 3, 4 and 9, when the plug 8 is not extended into the cavity 13, the contact portion 614 of the first switch component 61 and the contact portion 624 of the second switch component 62 are spaced apart from each other and do not make electrical contact with each other. As shown in FIG. 10, once the plug 8 is extended into the cavity 13, it urges the contact portion 624 of the second switch component 62 to make electrical contact with the contact portion 614 of the first switch component 61. In this embodiment, the plug 8 abuts against the abutting part 625 of the contact portion 624 when extended into the cavity 13, causing the connecting portion 623 of the second switch component 62 to bend and move the contact portion 624 of the second switch component 62 toward the contact portion 614 of the first switch component 61, so as to establish electrical contact between the first and the second switch components 61, 62. The primary function of the detecting switch 6 is to enable generation of an indication when the plug 8 is fully extended into the cavity 13, i.e., to enable generation of indicating lights (not shown) or sounds upon establishing electrical contact between the contact portions 614 and 624 of the first and second switch components 61 and 62.

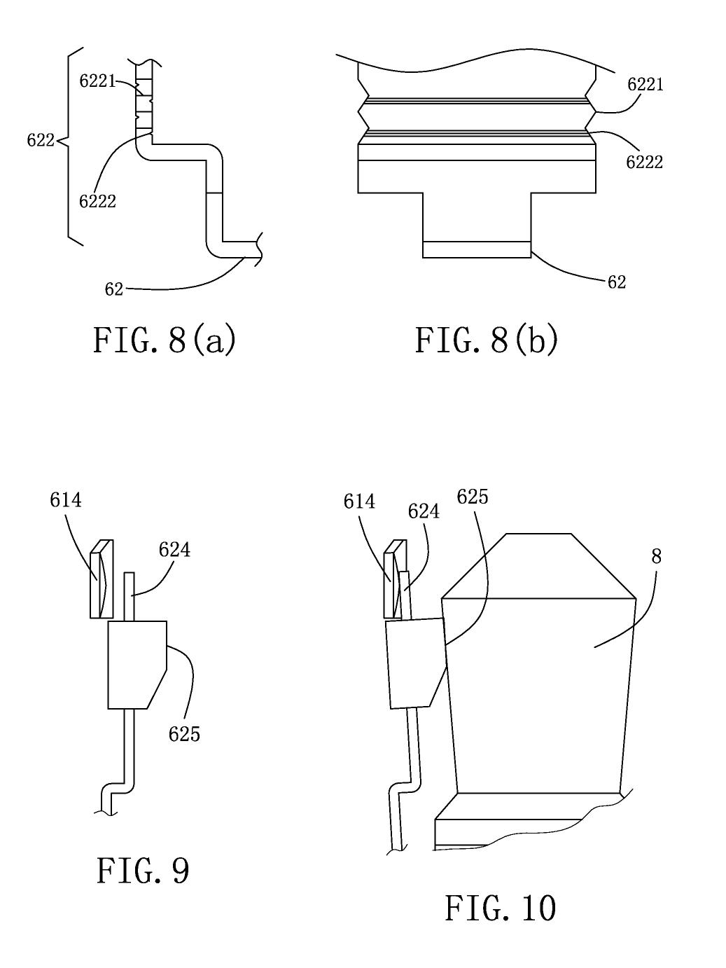

As shown in FIGS. 7(a), 7(b), 8(a), and 8(b), the embedding portion 612, 622 of each of the first and second switch components 61 and 62 preferably has a surface formed with at least one groove 6122, 6222. The embedding portion 612, 622 of each of the first and second switch components 61, 62 preferably is further formed with at least one protrusion 6121, 6221 protruding therefrom and embedded in the first housing portion 11. The grooves 6122, 6222 and the protrusions 6121, 6221 have the same functions as those of the contact members 3.

As shown in FIGS. 2, 3, 4, and 5, when assembling the first preferred embodiment of the waterproof electrical socket connector 100, the embedding portions 32, 612, 622 of the contact members 3 and the detecting switch 6 are first embedded into the first housing portion 11 by insert molding, followed by coupling the first housing portion 11 with the second housing portion 12 through the engagements between the male engaging part 126 and the female engaging part 112, between the tenon 127, 128 and the motise 117, 118 of each of the joint structures, and between the elongate rib 125 and the elongate trench 111. Moreover, the mating surfaces of the first housing portion 11 and the second housing portion 12 are subjected to laser or ultrasonic treatment for connecting the same.

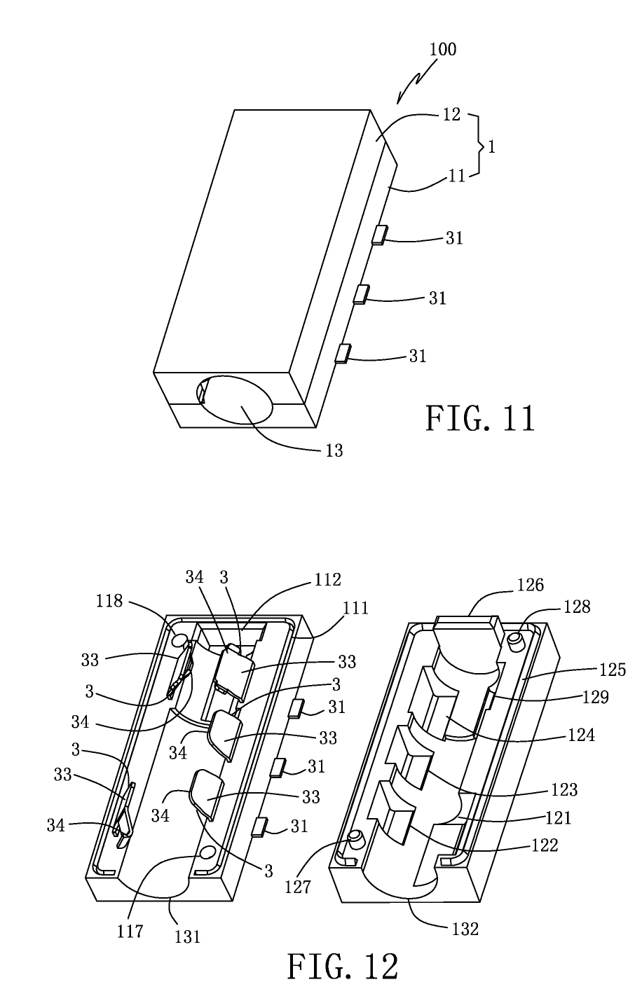

Referring to FIGS. 11 and 12, the second preferred embodiment of the waterproof electrical socket connector 100 according to the present invention is shown to be similar in construction to the first preferred embodiment. The difference therebetween resides in that the waterproof electrical socket connector 100 of the second preferred embodiment has five contact members 3 instead of four, while the detecting switch 6 is omitted from the second preferred embodiment. The second preferred embodiment has the same waterproofing effect as the first preferred embodiment.

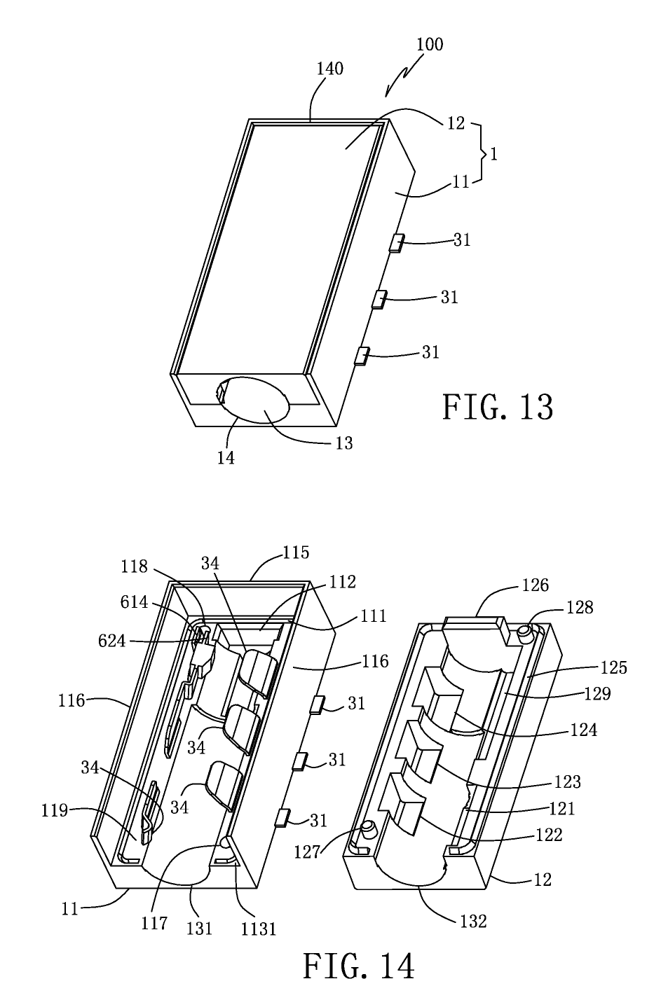

Referring to FIGS. 13 and 14, the third preferred embodiment of the waterproof electrical socket connector 100 according to the present invention is shown to be similar in construction to the first preferred embodiment. The main difference therebetween resides in the configuration of the first housing portion 11. In the third preferred embodiment, the first housing portion 11 has a mating surface 1131 for placement of the second housing portion 12 thereon, the mating surface 1131 having two lateral surface parts respectively adjacent to two lateral sides of the cavity 13, and an end surface part that interconnects the lateral surface parts and that is disposed opposite to the opening 14. The first housing portion 11 further has two side walls 116 that respectively project from and extend along the lateral surface parts of the mating surface 1131, and a connecting wall 115 that projects from the end surface part of the mating surface 1131 and that interconnects the side walls 116. The side walls 116 and the connecting wall 115 cooperatively define a receiving space 119 for fittingly receiving the second housing portion 12. In this embodiment, the second housing portion 12 has an outer surface opposite to the first housing portion 11, and the side walls 116 and the connecting wall 115 have terminating surfaces that are flush with the outer surface of the second housing portion 12. In this embodiment, the waterproof electrical socket connector 100 preferably comprises an adhesive 140 that fills gaps between the second housing portion 12 and the side walls 116 and the connecting wall 115 of the first housing portion 11 to further assure the waterproofing effect of the present invention.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A waterproof electrical socket connector adapted for coupling with a plug, said waterproof electrical socket connector comprising:
a connector housing including a first housing portion and a second housing portion coupled to and configured to cover said first housing portion, said first housing portion and said second housing portion cooperatively defining a cavity and an opening that is configured to permit extension of the plug into said cavity; and
a plurality of contact members each of which includes a terminal portion, a contact portion, and an embedding portion that interconnects said terminal portion and said contact portion, said embedding portion being fittingly and sealingly embedded in said first housing portion by insert molding, said terminal portion extending outwardly of said first housing portion, said contact portion extending into said cavity for establishing electrical contact with the plug.

2. The waterproof electrical socket connector as claimed in claim 1, wherein said embedding portion has a surface formed with at least one groove.

3. The waterproof electrical socket connector as claimed in claim 2, wherein said embedding portion further has at least one protrusion protruding therefrom and embedded in said first housing portion.

4. The waterproof electrical socket connector as claimed in claim 1, wherein said embedding portion has at least one protrusion protruding therefrom and embedded in said first housing portion.

5. The waterproof electrical socket connector as claimed in claim 1, wherein said cavity extends along an axis, and said opening is circular and is disposed along the axis at one end of said cavity.

6. The waterproof electrical socket connector as claimed in claim 1, wherein said first housing portion and said second housing portion have confronting cavity defining surfaces that cooperate to define said cavity, said cavity defining surface of one of said first and second housing portions being formed with a male engaging part that extends into said cavity at a location distal from said opening, said cavity defining surface of the other one of said first and second housing portions being formed with a female engaging part to engage said male engaging part.

7. The waterproof electrical socket connector as claimed in claim 1, wherein said first housing portion and said second housing portion have confronting mating surfaces provided with a pair of joint structures that are diagonally opposite to each other, each of said joint structures including a tenon provided on said mating surface of one of said first and second housing portions, and a mortise provided on said mating surface of the other one of said first and second housing portions and disposed to engage said tenon.

8. The waterproof electrical socket connector as claimed in claim 1, wherein said first housing portion and said second housing portion have confronting mating surfaces, said mating surface of one of said first and second housing portions being formed with an elongate rib, said mating surface of the other one of said first and second housing portions being formed with an elongate trench to engage said rib.

9. The waterproof electrical socket connector as claimed in claim 8, wherein said opening is disposed at one end of said cavity, and said elongate rib and said elongate trench are configured to surround two lateral sides of said cavity and another end of said cavity opposite to said opening.

10. The waterproof electrical socket connector as claimed in claim 1, further comprising a detecting switch that includes:
a first switch component having a terminal portion, a contact portion, and an embedding portion that interconnects said terminal portion and said contact portion of said first switch component, said embedding portion of said first switch component being fittingly and sealingly embedded in said first housing portion by insert molding, said terminal portion of said first switch component extending outwardly of said first housing portion, said contact portion of said first switch component extending into said cavity; and
a second switch component having a terminal portion, a contact portion, and an embedding portion that interconnects said terminal portion and said contact portion of said second switch component, said embedding portion of said second switch component being fittingly and sealingly embedded in said first housing portion by insert molding, said terminal portion of said second switch component extending outwardly of said first housing portion, said contact portion of said second switch component extending into said cavity, extending adjacent to said contact portion of said first switch component, and being urged by the plug to make contact with said contact portion of said first switch component when the plug is extended into said cavity.

11. The waterproof electrical socket connector as claimed in claim 10, wherein said embedding portion of each of said first and second switch components has a surface formed with at least one groove.

12. The waterproof electrical socket connector as claimed in claim 10, wherein said embedding portion of each of said first and second switch components is formed with at least one protrusion protruding therefrom and embedded in said first housing portion.

13. The waterproof electrical socket connector as claimed in claim 1, wherein said opening is disposed at one end of said cavity,
said first housing portion having a mating surface for placement of said second housing portion thereon, said mating surface having two lateral surface parts respectively adjacent to two lateral sides of said cavity, and an end surface part interconnecting said lateral surface parts and disposed opposite to said opening,
said first housing portion further having two side walls that respectively project from and extend along said lateral surface parts of said mating surface, and a connecting wall that projects from said end surface part of said mating surface and that interconnects said side walls,
said side walls and said connecting wall cooperatively defining a receiving space for fittingly receiving said second housing portion.

14. The waterproof electrical socket connector as claimed in claim 13, wherein said second housing portion has an outer surface opposite to said first housing portion, and said side walls and said connecting wall having terminating surfaces that are flush with said outer surface of said second housing portion.

15. The waterproof electrical socket connector as claimed in claim 14, further comprising an adhesive that fills gaps between said second housing portion and each of said side walls and said connecting wall.
